(19) United States
(12) Patent Application Publication
(10) Pub. No.: US 2022/0165162 A1
(43) Pub. Date: May 26, 2022

(54) ROUTE OPTIMIZATION FOR ENERGY INDUSTRY INFRASTRUCTURE INSPECTION

(71) Applicant: SeekOps Inc., Austin, TX (US)

(72) Inventors: Brendan James Smith, Lakeway, TX (US); Victor Alexander Miller, II, Austin, TX (US); Michael Price McGuire, Austin, TX (US); Stuart Buckingham, Austin, TX (US)

(21) Appl. No.: 17/601,623

(22) PCT Filed: Apr. 1, 2020
(86) PCT No.: PCT/US20/26246

§ 371 Date: Oct. 5, 2021

Related U.S. Application Data
(60) Provisional application No. 62/829,770, filed on Apr. 5, 2019.

(51) Int. Cl. G08G 5/00; B64C 39/02

(52) U.S. Cl. CPC G08G 5/003; B64C 39/024

(57) ABSTRACT

Systems, devices, and methods including receiving, by a processor having addressable memory, a spatial location of one or more known assets; determining, by the processor, one or more clusters based on the received spatial location of the one or more known assets; determining, by the processor, a bound for each asset of the one or more known assets in each cluster; and determining, by the processor, a flight plan for an aerial vehicle for each cluster, where the flight plan surveys each asset in each cluster.

### CROSS-REFERENCE TO RELATED APPLICATION

This application is a 35 U.S.C § 371 National Stage Entry of International Application No. PCT/US2020/026246, filed Apr. 1, 2020, which claims the priority benefit of U.S. Provisional Patent Application Ser. No. 62/829,770 filed Apr. 5, 2019, all of which are incorporated herein by reference in their entirety for all purposes.

### FIELD OF ENDEAVOR

The invention relates to gas leak detection, and more particularly to route optimization for gas leak detection.

### BACKGROUND

Trace gas sensors are used to detect and quantify leaks of toxic gases, e.g., hydrogen disulfide, or environmentally damaging gases, e.g., methane and sulfur dioxide, in a variety of industrial and environmental contexts. Detection and quantification of these leaks are of interest to a variety of industrial operations, e.g., oil and gas, chemical production, and painting, as well as environmental regulators for assessing compliance and mitigating environmental and safety risks.

### SUMMARY

A method embodiment may include: receiving, by a processor having addressable memory, a spatial location of one or more known assets; determining, by the processor, one or more clusters based on the received spatial location of the one or more known assets; determining, by the processor, a bound for each asset of the one or more known assets in each cluster, where each bound comprises a minimum distance from each asset and a maximum distance from each asset; and determining, by the processor, a flight plan for an aerial vehicle for each cluster, where the flight plan surveys each asset in each cluster.

Additional method embodiments may include: receiving, by the processor, a spatial location having one or more known assets. Additional method embodiments may include: adjusting, by the processor, a cluster of the one or more clusters based on one or more known assets within a proximity to the cluster of the one or more clusters. Additional method embodiments may include: determining, by the processor, a location of a launch platform for an aerial vehicle having one or more sensors.

In additional method embodiments, the determined bound may be based on at least one of: a wind data, an asset type, and a user preference. In additional method embodiments, the determined bound may include a minimum distance from a known asset of the one or more known assets. In additional method embodiments, the determined bound may further include a maximum distance from the known asset of the one or more known assets. In additional method embodiments, the flight plan may be based on at least one of: a timeframe, a topology of the cluster, the determined bound for each asset, a wind data, an asset type for each asset, a user preference, a location of a launch platform for the aerial vehicle, a power level of the aerial vehicle, one or more constraints, and one or more cost functions. Additional method embodiments may include: determining, by the processor, a sub-cluster of one or more known assets, where the determined sub-cluster may be based on a location of one or more known assets grouped within a set proximity, wherein the flight plan surveys each sub-cluster as a single asset.

A system embodiment may include: an aerial vehicle; a global positioning system disposed on the aerial vehicle to determine a location of the aerial vehicle; at least one sensor disposed on the aerial vehicle, the at least one sensor configured to generate sensor data; and a processor having addressable memory, the processor configured to: receive a spatial location of one or more known assets; determine one or more clusters based on the received spatial location of the one or more known assets; determine a bound for each asset of the one or more known assets in each cluster; and determine a flight plan for the aerial vehicle for each cluster, where the flight plan surveys each asset in each cluster.

In additional system embodiments, the processor may be further configured to receive a spatial location having one or more known assets. In additional system embodiments, the processor may be further configured to adjust a cluster of the one or more clusters based on one or more known assets within a proximity to the cluster of the one or more clusters. In additional system embodiments, the processor may be further configured to: determine a location of a launch platform for an aerial vehicle having one or more sensors. In additional system embodiments, the determined bound may be based on at least one of: a wind data, an asset type, and a user preference. In additional system embodiments, the determined bound may include a minimum distance from a known asset of the one or more known assets. In additional system embodiments, the determined bound may further include a maximum distance from the known asset of the one or more known assets.

In additional system embodiment, the flight plan may be based on at least one of: a timeframe, a topology of the cluster, the determined bound for each asset, a wind data, an asset type for each asset, a user preference, a location of a launch platform for the aerial vehicle, a power level of the aerial vehicle, one or more constraints, and one or more cost functions. In additional system embodiments, the processor may be further configured to: determine a sub-cluster of one or more known assets, wherein the determined sub-cluster is based on a location of one or more known assets grouped within a set proximity, wherein the flight plan surveys each sub-cluster as a single asset.

An additional system embodiment may include: a portable device; a global positioning system disposed on the portable device to determine a location of the portable device; at least one sensor disposed on the portable device, the at least one sensor configured to generate sensor data; and a processor having addressable memory, the processor configured to: receive a spatial location of one or more known assets; determine one or more clusters based on the received spatial location of the one or more known assets; determine a bound for each asset of the one or more known assets in each cluster; and determine a plan for the portable device for each cluster, where the plan surveys each asset in each cluster. In additional system embodiments, the portable device may be a mobile platform.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts an area having one or more single assets and an area of interest, according to one embodiment;

FIG. 2A depicts the area of interest of FIG. 1 with one or more clusters, according to one embodiment;

FIG. 2B depicts a flight plan for a cluster of the one or more clusters of FIG. 2A, according to one embodiment;

FIG. 3 depicts a high-level block diagram of a route optimization system, according to one embodiment; and

FIG. 4 depicts a high-level flowchart of a method embodiment of route optimization for inspecting one or more single assets in an area of interest, according to one embodiment;

FIG. 5 shows a high-level block diagram and process of a computing system for implementing an embodiment of the system and process;

FIG. 6 shows a block diagram and process of an exemplary system in which an embodiment may be implemented; and

FIG. 7 depicts a cloud computing environment for implementing an embodiment of the system and process disclosed herein.

### DETAILED DESCRIPTION

The following description is made for the purpose of illustrating the general principles of the embodiments disclosed herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

The present system allows for dividing an area containing dispersed assets into clusters and optimizing a flight path to inspect one or more single assets in each cluster. An area may have dispersed infrastructure, such as oil and gas equipment, power lines, and the like. The disclosed system and method allow for this dispersed area to be divided up into clusters, where each cluster may contain one or more known assets to be surveyed. A flight plan may be created to survey these known assets that takes into account time, topology, wind conditions, a power level of an aerial vehicle, and the like. The flight path may be generated based on a set of constraints and/or one or more cost functions. The clusters may be modified to include known assets proximate to the cluster. Similar known assets within a set proximity can be grouped into a sub-cluster for more efficient analysis. The aerial vehicle may have one or more sensors, such as gas sensors, EO/IR sensors, and visual sensors to receive sensor data on gas readings, visual information, and the like. The system and method may also allow for the placement of an aerial vehicle launch platform situated such that the known assets in the cluster may be surveyed in the optimal flight path.

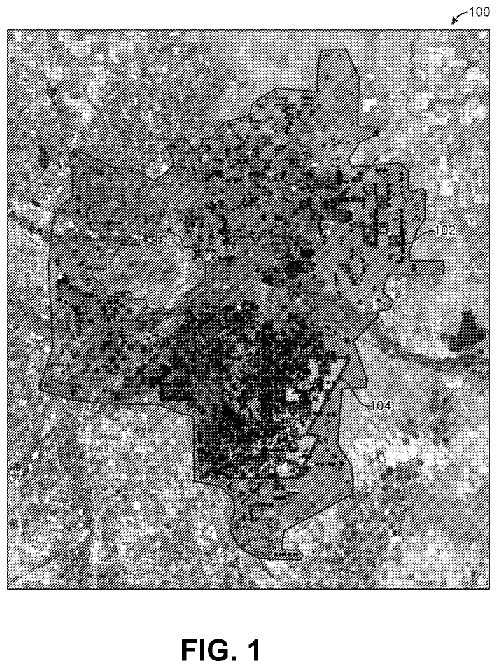

FIG. 1 depicts an area 100 having one or more single assets 102 and an area of interest 104, according to one embodiment. The assets 102 may be any spaced out infrastructure. In some embodiments, the assets may include oil and gas infrastructure, such as refineries, storage, and the like.

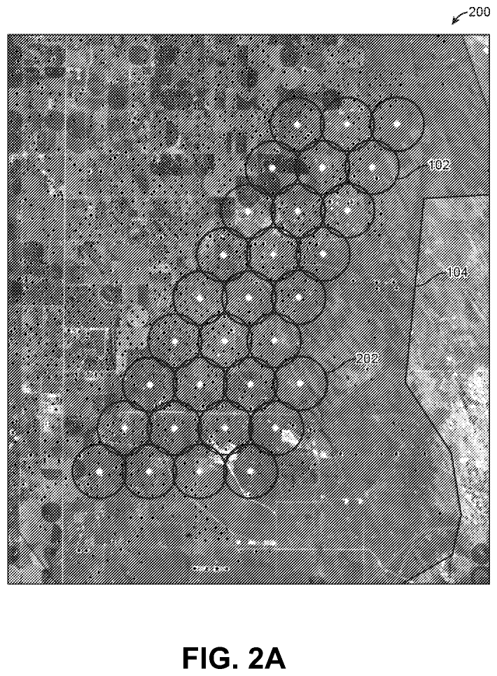

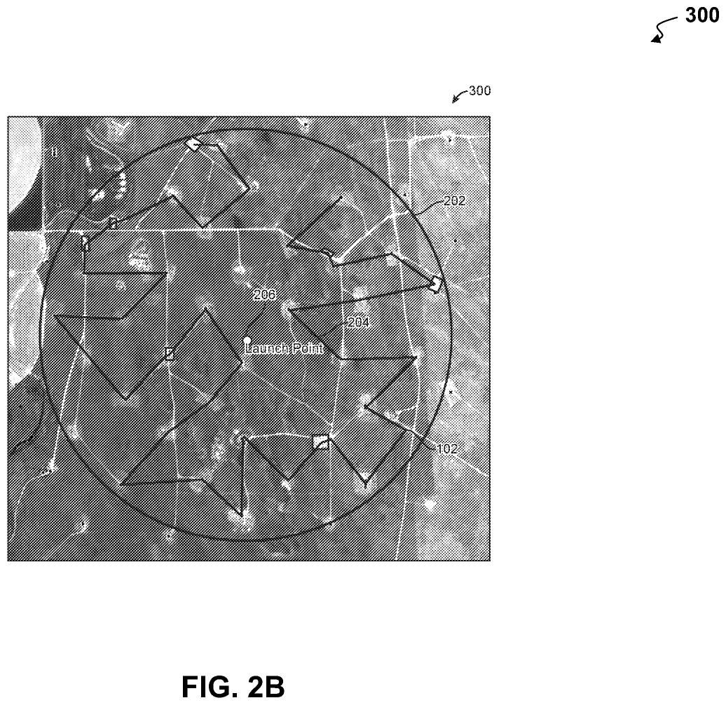

FIG. 2A depicts the area of interest 104 of FIG. 1 with one or more clusters 202, according to one embodiment. The clusters 202 may be created in a somewhat uniform manner. In some embodiments, each cluster 202 may have a substantially similar area of coverage. The clusters may be created with a K-means algorithm in one embodiment. In other embodiments, other clustering algorithms may be used to divide an area having spaced out infrastructure into a plurality of clusters. While the clusters 202 are shown as circles, the clusters 202 may be any closed-shape polygon, such as a circle, triangle, rectangle, hexagon, or the like. In one embodiment, the cluster 202 are created in such a way as to have as little overlap with adjacent clusters 202 while leaving little to know gaps in area between adjacent clusters 202.

FIG. 2B depicts the area 300 having a flight plan 204 for a cluster 202 of the one or more clusters 202 of FIG. 2A, according to one embodiment. The clusters 202 may include one or more assets 102. The centroid of each cluster may be a launch point 206. In some embodiments, the launch point 206 may be close to the centroid of the cluster 202. In other embodiments, the launch point 206 may be elsewhere in the cluster 202. In some embodiments, the launch point 206 may be outside the cluster 202. The launch point 206 may be the location of a fixed launch platform. The fixed launch platform may store an aerial vehicle when not in use and allow for regular, or periodic, surveys of the one or more known assets 102. In one embodiment, the aerial vehicle is an unmanned aerial vehicle (UAV). In other embodiments, the launch point 206 may be temporary and determined so as to maximize an efficiency of surveying each of the one or more assets 102 in each cluster 202.

The flight plan 204 may be created by a planning algorithm to survey each asset 102 within each cluster 202. In one embodiment, the planning algorithm determines the flight plan 204 before launch of the aerial vehicle. The determined flight plan 204 may take into account weather, topology, altitude of flight, and the like. In other embodiments, the planning algorithm may adjust the flight plan 204 in real time, for example, due to unforeseen changes in weather conditions. In one embodiment, the disclosed system and method allows all of the assets 102 to be surveyed within a specified amount of time, such as two hours. The specified amount of time may depend on the weather conditions, vehicle conditions, battery life of the aerial vehicle, and the like. In some embodiments, the topology of the ground is factored in as flying uphill, flying downhill, and/or changing altitude frequently effects the efficiency of the aerial vehicle. Starting at highest altitude and going to next lowest altitude asset 102 may increase efficiency in some embodiments. Flying into the wind may reduce flight time. A flight path that is downwind of multiple assets 102 could rule out a gas leak from multiple assets 102. The number of assets 102 to be surveyed may be based on one or more of: time, topology, wind conditions, and power level. Each of the assets 102 may be surveyed once a day or based on whatever timeframe is set by the user and/or customer.

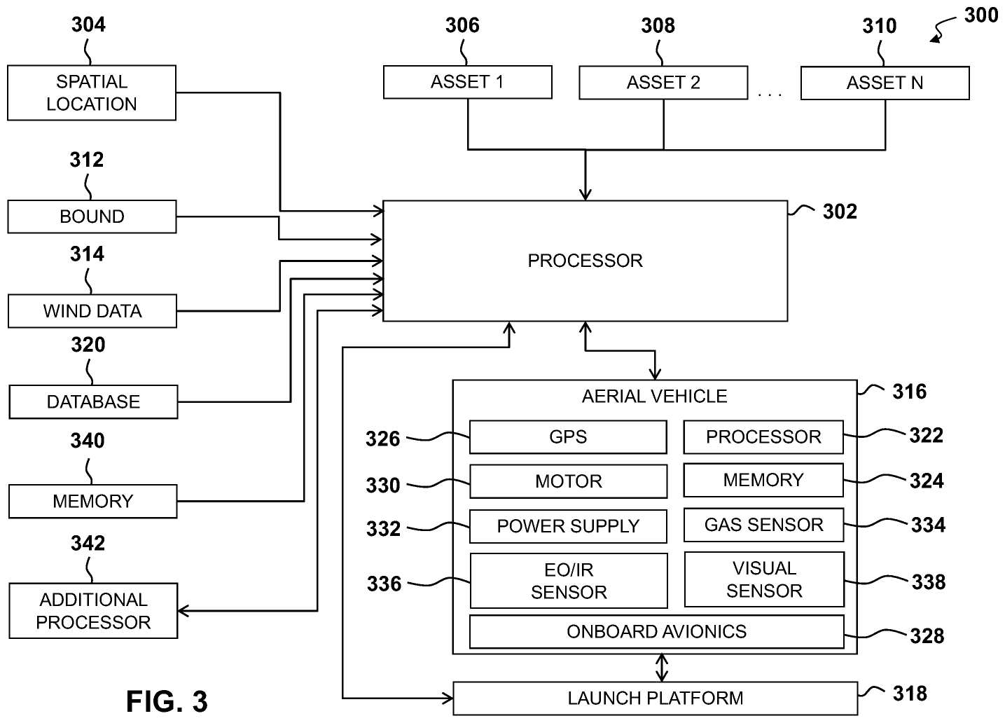

FIG. 3 depicts a high-level block diagram of a route optimization system 300, according to one embodiment. The system includes a processor 302. The processor 302 receives a spatial location 304, which may be an area containing one or more known assets 306, 308, 310 to be surveyed. The processor 302 also receives the spatial location of the one or more known assets 306, 308, 310 within the spatial location 804. In some embodiments, the one or more known assets 306, 308, 310 may be equipment and/or locations more likely to leak trace-gases and/or toxic gases, such as hydrogen disulfide, or environmentally damaging gases, such as methane and sulfur dioxide. In other embodiments, the one or more known assets 306, 308, 310 may be equipment, infrastructure, or the like to be surveyed, such as high voltage power lines. In some embodiments, the one or more known assets 306, 308, 310 may include one or more of: assets that may potentially emit gasses, assets needing a visual inspection, assets needing an electro-optical inspection, and assets needing an infrared inspection.

The processor 302 may determine one or more clusters based on the received spatial location of the one or more known assets 306, 308, 310. In some embodiments, the processor 302 may adjust one or more of the one or more clusters based on one or more of the known assets 306, 308, 310 being within a proximity of the one or more clusters. For example, if a known asset is just outside of a cluster, the processor 302 may adjust the cluster to include this proximate asset. The proximity may be set based on a set distance, a set time to reach, a proximity of nearby assets, or the like. For example, if an asset is just outside of the cluster, but not near any other known assets, then the asset may be excluded and the cluster may not be adjusted. As another example, if an asset is further outside of the cluster but multiple assets are grouped proximate the border of the cluster, then the asset may be included in the cluster and the cluster may be adjusted to include the asset. The cluster may be any closed shape, such as a circle, rectangle, hexagon, polygon, or the like.

The processor 302 may also receive and/or determine a bound 312 for each known asset 306, 308, 310. The bound 312 is at least one of: a minimum distance from a known asset and a maximum distance from a known asset. In some embodiments, the bound 312 may vary based on wind data 314. In other embodiments, the bound 312 may vary based on internal safety regulations for each customer. For example, one customer of a known asset may allow surveying up to twelve feet from an asset while another customer may only allow surveying up to seventy-five feet from an asset. In some embodiments, the bound 312 may vary based on the type of asset. For example, a drilling rig may have a larger bound than a pipeline. Moving elements, the potential presence of workers, laws, rules, and other factors may impact the bound for each asset. For example, low voltage power lines may have a smaller bound than high voltage power lines. In some embodiments, the bound 312 may be fixed based on preferences, such as set minimum and maximum distances, regulations, and the like. In other embodiments, the bound 312 may include variable factors, such as wind data 314, variable risk factors, historical data from prior surveys, time from last survey, and the like.

The processor 302 may also receive wind data 314. Wind data 314 may include wind speed and/or wind direction for the spatial location 304. In some embodiments, wind data 314 may also include predictions as to changes in the wind speed and/or wind direction. Wind data 314 may include a single wind direction and wind speed or multiple wind directions and multiple wind speeds. In some embodiments, wind data 314 may be used by the processor 302 to determine the bound 312 for each known asset 306, 308, 310. In one embodiment, the bound 312 size may increase with increasing wind speed. In another embodiment, the bound 312 size may decrease with decreasing wind speed. Variations in wind speed and direction may impact the accuracy of sensor readings for trace-gas at certain reading locations and require that the bound be adjusted to maintain a desired accuracy. In some embodiments, wind data 314 may also be used by the processor 302 to determine a location of the launch platform 318. In some embodiments, wind data 314 may also be used by the processor 302 to determine a flight path of the aerial vehicle 316. In some embodiments, the aerial vehicle 316 may instead be a portable device and/or a mobile platform.

The processor 302 may then determine a location of the launch platform 318 for the aerial vehicle 316. In some embodiments, the location of the launch platform 318 may be a centroid, or center, of each cluster. In other embodiments, the location of the launch platform 318 may be at an optimal location for a flight plan of the aerial vehicle 316 to fly a flight plan and survey each known asset 306, 308, 310 within a cluster. The location of the launch platform 318 may be fixed in an embodiment where the launch platform stores the aerial vehicle 316 and the aerial vehicle 316 performs periodic flight plans to survey the known assets 306, 308, 310 within the cluster. In other embodiments, the location of the launch platform 318 may be temporary in an embodiment where the launch platform 318 is determined for a one-time, or less frequent, surveying of the known assets 306, 308, 310 within the cluster.

The processor 302 may then determine a flight path for an aerial vehicle 316 for each cluster. Each aerial vehicle 316 may survey one cluster. In another embodiment, an aerial vehicle 316 may survey more than one cluster. In yet another embodiment, more than one aerial vehicle 316 may survey the same cluster for redundancy. The flight path for the aerial vehicle 816 covers the one or more known assets 306, 308, 310 based on their respective bounds 312 determined by the processor 302. The aerial vehicle 316 may be an unmanned aerial vehicle (UAV) in some embodiments. The aerial vehicle 316 may have a processor 322 in communication with addressable memory 324, a GPS 326, an onboard avionics 328, one or more motors 330, a power supply 332, and one or more sensors, such as a gas sensor 334, an EO/IR sensor 336, and a visual sensor 338. The aerial vehicle 316 may receive the flight plan from the processor 302 and communicate gathered data from the gas sensor 334 sensor, the EO/IR sensor 336, and/or the visual sensor 338 to the processor 302. The GPS 326 and/or onboard avionics 328 may record the location of the aerial vehicle 316 when each sensor data is acquired. The GPS 326 and/or onboard avionics 328 may also allow the aerial vehicle 316 to travel the flight path generated by the processor 302. In some embodiments, the location of the aerial vehicle 316 may be determined by an onboard avionics 328. The onboard avionics 328 may include a triangulation system, a beacon, a spatial coordinate system, or the like. The onboard avionics 328 may be used with the GPS 326 in some embodiments. In other embodiments, the aerial vehicle 316 may use only one of the GPS 326 and the onboard avionics 328.

In some embodiments, the processor 302 may determine a sub-cluster based on a location of one or more known assets 306, 308, 310 that are grouped within a set proximity. For example, if a group of known assets 306, 308, 310 are to be surveyed for gas leaks and are within a set proximity, then the aerial vehicle 316 flight plan may fly downwind of this group of known assets 306, 308, 310 and may be able to determine if there is a gas leak for any of these assets collectively. For example, if no gas is detected, then a more detailed survey may not be required and the flight plan may be optimized to survey the remaining known assets 306, 308, 310 and/or sub-clusters of remaining known assets 306, 308, 310. As another example if trace-gas is detected, then the flight plan may be modified and/or retain its original course to determine which asset of the sub-cluster of known assets 306, 308, 310 has the gas leak from the detected trace-gas.

The power supply 332 may be a battery in some embodiments. The power supply 332 may limit the available flight time for the aerial vehicle 316. In some embodiments, the flight plan may be split up into two or more flights based on a size of the cluster, a number of known assets 306, 308, 310 in the cluster, a flight time of the aerial vehicle 316, weather conditions, and the like. In some embodiments, the processor 302 may be a part of the aerial vehicle 316, a cloud computing device, a ground control station (GCS) used to control the aerial vehicle 316, or the like.

The flight plan surveys each known asset 306, 308, 310 in the cluster. In some embodiments, the flight plan may include a timeframe, a topology of the cluster, the determined bound for each asset, the wind data 314, the asset type for each asset, a user preference, the determined location of the launch platform 318, one or more constraints, and/or one or more cost functions. These factors may be stored in a database 320, such as a user preference database, a settings database, or the like. The constraints may include wind data 314, take-off and landing locations of the aerial vehicle 316, and the like. Cost functions may include an elevation profile of the spatial location 304, a topology of the spatial location 304, wind data 314, and the like.

The processor 302 may receive sensor data from the one or more gas sensors 334, EO/IR sensors 336, and/or visual sensors 338 of the aerial vehicle 316. The number of type of sensors may depend on the type of known asset 306, 308, 310 to be surveyed. For example, if none of the known assets 306, 308, 310 have a potential to leak gas, then the aerial vehicle 316 may not use a gas sensor 334. As another example, if none of the know assets 306, 308, 310 require a visual inspection and/or a customer does not desire a visual inspection, then the aerial vehicle 316 may not use an EO/IR sensor 336 and/or a visual sensor 338. The processor may then determine, based on the received sensor data, whether a gas leak is present for one or more of the known assets 306, 308, 310, whether a repair is needed for one or more of the known assets 306, 308, 310, whether corrective action may be needed for one or more of the known assets 306, 308, 310, or the like.

In some embodiments, the processor 302 may be in communication with addressable memory 340. The memory 340 may store the result of whether a gas leak and/or visual defect was detected, historical sensor data, the received spatial location 304, known asset 306, 308, 310 locations and/or types, wind data 314, preferences in the database 320, and/or aerial vehicle 316 information. In some embodiments, the processor 302 may be in communication with an additional processor 342. The additional processor 342 may be a part of the aerial vehicle 316, a cloud computing device, a GCS used to control the aerial vehicle 316, or the like.

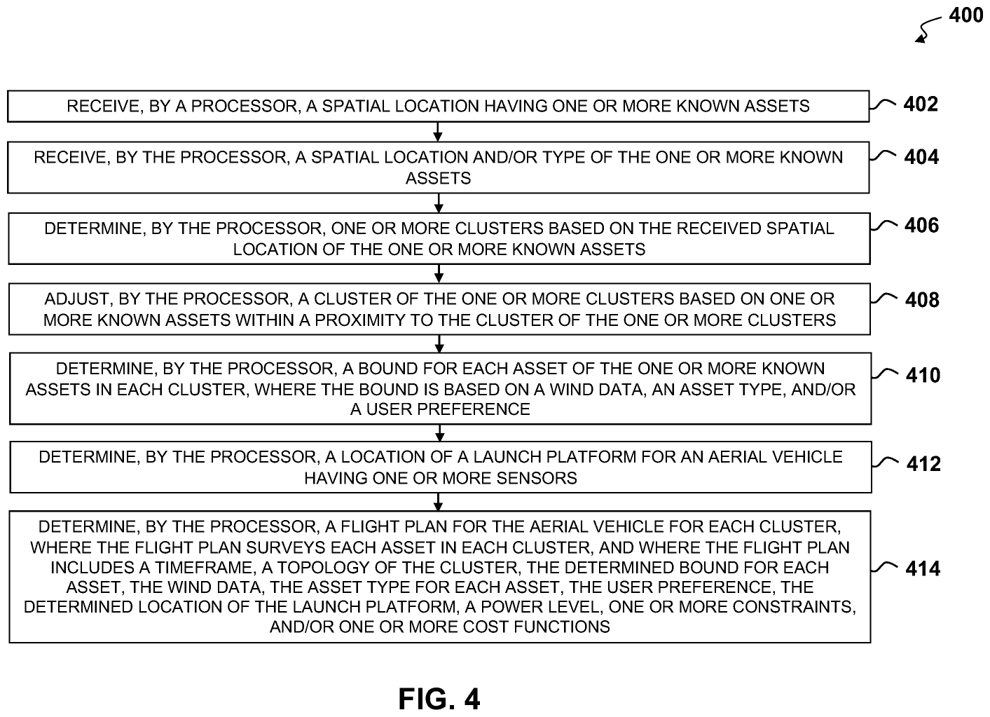

FIG. 4 depicts a high-level flowchart of a method embodiment 400 of route optimization for inspecting one or more single assets in an area of interest, according to one embodiment. The method 400 may include receiving, by a processor having addressable memory, a spatial location having one or more known assets (step 402). In some embodiments, receiving the spatial location (step 402) may be optional and the spatial location may be inferred based on the spatial location of the one or more known assets (step 404). The set of known assets may be in an (x,y) space. The method 400 may then include receiving, by the processor, a spatial location and/or type of the one or more known assets (step 404). The method 400 may then include determining, by the processor, one or more clusters based on the received spatial location of the one or more assets (step 406). The number of clusters in the spatial area may be determined via a K-means iterator algorithm or other clustering algorithm, in some embodiments. The K-means iterator may be run for a<r<b, to determine the number of centroids and locations in the (x,y) space.

The method 400 may then include adjusting, by the processor, a cluster of the one or more clusters based on one or more known assets within a proximity to the cluster of the one or more clusters (step 408). By adjusting the cluster, nearby assets may be included in the cluster to optimize the assets being surveyed in each cluster. The method 400 may then include determining, by the processor, a bound for each asset of the one or more known assets in each cluster, where the bound is based on a wind data, an asset type, and/or a user preference (step 410). The method may then include determining, by the processor, a location of a launch platform for an aerial vehicle having one or more sensors (step 412). The location of the launch platform may be a permanent location for a fixed launch platform or a temporary launch platform for a one-time survey of the known assets in the cluster. In some embodiments, the launch platform may be at a centroid, or near a center, of each cluster.

The method 400 may then include determining, by the processor, a flight plan for the aerial vehicle for each cluster, where the flight plan surveys each asset in each cluster, and where the flight plan includes a timeframe, a topology of the cluster, the determined bound for each asset, the wind data, the asset type for each asset, the user preference, the determined location of the launch platform, a power level, one or more constraints, and/or one or more cost functions (step 414). A path planning algorithm may be applied for path optimization. The path planning algorithm may be a traveling salesman algorithm, a continuous-time random walk (CTRW), or the like. The set of constrains may include starting furthest away and most upwind and/or ending closest to the centroid. The cost functions (gradient descent) may include an elevation profile and/or a wind vector. The method 400 may also include running local proximity using buffer and intersection to combine close-in-proximity assets inspections; applying an inspection flight path, such as a circular pattern or box; and selection output with grading.

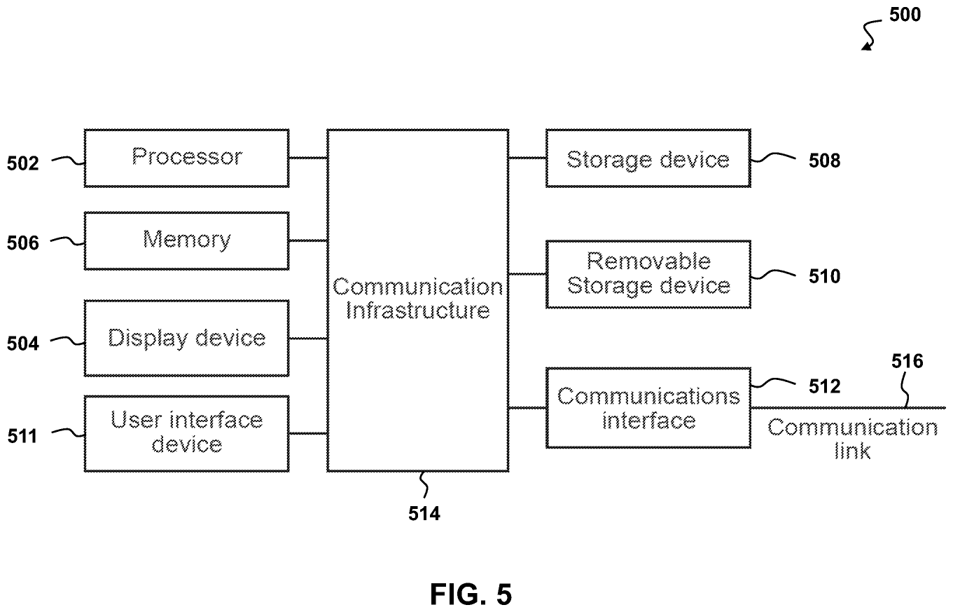

FIG. 5 is a high-level block diagram 500 showing a computing system comprising a computer system useful for implementing an embodiment of the system and process, disclosed herein. Embodiments of the system may be implemented in different computing environments. The computer system includes one or more processors 502, and can further include an electronic display device 504 (e.g., for displaying graphics, text, and other data), a main memory 506 (e.g., random access memory (RAM)), storage device 508, a removable storage device 510 (e.g., removable storage drive, a removable memory module, a magnetic tape drive, an optical disk drive, a computer readable medium having stored therein computer software and/or data), user interface device 511 (e.g., keyboard, touch screen, keypad, pointing device), and a communication interface 512 (e.g., modem, a network interface (such as an Ethernet card), a communications port, or a PCMCIA slot and card). The communication interface 512 allows software and data to be transferred between the computer system and external devices. The system further includes a communications infrastructure 514 (e.g., a communications bus, cross-over bar, or network) to which the aforementioned devices and modules are connected as shown.

Information transferred via communications interface 514 may be in the form of signals such as electronic, electromagnetic, optical, or other signals capable of being received by communications interface 514, via a communication link 516 that carries signals and may be implemented using wire or cable, fiber optics, a phone line, a cellular/mobile phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 512. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

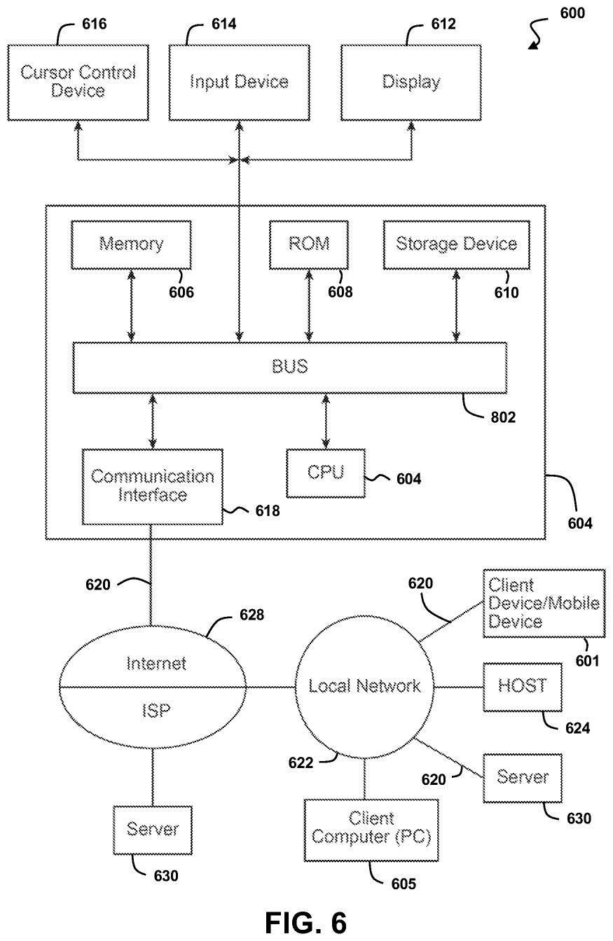

FIG. 6 shows a block diagram of an example system 600 in which an embodiment may be implemented. The system 600 includes one or more client devices 601 such as consumer electronics devices, connected to one or more server computing systems 630. A server 630 includes a bus 602 or other communication mechanism for communicating information, and a processor (CPU) 604 coupled with the bus 602 for processing information. The server 630 also includes a main memory 606, such as a random access memory (RAM) or other dynamic storage device, coupled to the bus 602 for storing information and instructions to be executed by the processor 604. The main memory 606 also may be used for storing temporary variables or other intermediate information during execution or instructions to be executed by the processor 604. The server computer system 630 further includes a read only memory (ROM) 608 or other static storage device coupled to the bus 602 for storing static information and instructions for the processor 604. A storage device 610, such as a magnetic disk or optical disk, is provided and coupled to the bus 602 for storing information and instructions. The bus 602 may contain, for example, thirty-two address lines for addressing video memory or main memory 606. The bus 602 can also include, for example, a 32-bit data bus for transferring data between and among the components, such as the CPU 604, the main memory 606, video memory and the storage 610. Alternatively, multiplex data/address lines may be used instead of separate data and address lines.

The server 630 may be coupled via the bus 602 to a display 612 for displaying information to a computer user. An input device 614, including alphanumeric and other keys, is coupled to the bus 602 for communicating information and command selections to the processor 604. Another type or user input device comprises cursor control 616, such as a mouse, a trackball, or cursor direction keys for communicating direction information and command selections to the processor 604 and for controlling cursor movement on the display 612.

According to one embodiment, the functions are performed by the processor 604 executing one or more sequences of one or more instructions contained in the main memory 606. Such instructions may be read into the main memory 606 from another computer-readable medium, such as the storage device 610. Execution of the sequences of instructions contained in the main memory 606 causes the processor 604 to perform the process steps described herein. One or more processors in a multi-processing arrangement may also be employed to execute the sequences of instructions contained in the main memory 606. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 604 for execution. Such a medium may take many forms, including but not limited to, non-volatile media, volatile media, and transmission media. Non-volatile media includes, for example, optical or magnetic disks, such as the storage device 610. Volatile media includes dynamic memory, such as the main memory 606. Transmission media includes coaxial cables, copper wire and fiber optics, including the wires that comprise the bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 604 for execution. For example, the instructions may initially be carried on a magnetic disk of a remote computer. The remote computer can load the instructions into its dynamic memory and send the instructions over a telephone line using a modem. A modem local to the server 630 can receive the data on the telephone line and use an infrared transmitter to convert the data to an infrared signal. An infrared detector coupled to the bus 602 can receive the data carried in the infrared signal and place the data on the bus 602. The bus 602 carries the data to the main memory 606, from which the processor 604 retrieves and executes the instructions. The instructions received from the main memory 606 may optionally be stored on the storage device 610 either before or after execution by the processor 604.

The server 630 also includes a communication interface 618 coupled to the bus 602. The communication interface 618 provides a two-way data communication coupling to a network link 620 that is connected to the world wide packet data communication network now commonly referred to as the Internet 628. The Internet 628 uses electrical, electromagnetic or optical signals that carry digital data streams. The signals through the various networks and the signals on the network link 620 and through the communication interface 618, which carry the digital data to and from the server 630, are exemplary forms or carrier waves transporting the information.

In another embodiment of the server 630, interface 618 is connected to a network 622 via a communication link 620. For example, the communication interface 618 may be an integrated services digital network (ISDN) card or a modem to provide a data communication connection to a corresponding type of telephone line, which can comprise part of the network link 620. As another example, the communication interface 618 may be a local area network (LAN) card to provide a data communication connection to a compatible LAN. Wireless links may also be implemented. In any such implementation, the communication interface 618 sends and receives electrical electromagnetic or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP). The ISP in turn provides data communication services through the Internet 628. The local network 622 and the Internet 628 both use electrical, electromagnetic or optical signals that carry digital data streams. The signals through the various networks and the signals on the network link 620 and through the communication interface 618, which carry the digital data to and from the server 630, are exemplary forms or carrier waves transporting the information.

The server 630 can send/receive messages and data, including e-mail, program code, through the network, the network link 620 and the communication interface 618. Further, the communication interface 618 can comprise a USB/Tuner and the network link 620 may be an antenna or cable for connecting the server 630 to a cable provider, satellite provider or other terrestrial transmission system for receiving messages, data and program code from another source.

The example versions of the embodiments described herein may be implemented as logical operations in a distributed processing system such as the system 600 including the servers 630. The logical operations of the embodiments may be implemented as a sequence of steps executing in the server 630, and as interconnected machine modules within the system 600. The implementation is a matter of choice and can depend on performance of the system 600 implementing the embodiments. As such, the logical operations constituting said example versions of the embodiments are referred to for e.g., as operations, steps or modules.

Similar to a server 630 described above, a client device 601 can include a processor, memory, storage device, display, input device and communication interface (e.g., e-mail interface) for connecting the client device to the Internet 628, the ISP, or LAN 622, for communication with the servers 630.

The system 600 can further include computers (e.g., personal computers, computing nodes) 605 operating in the same manner as client devices 601, wherein a user can utilize one or more computers 605 to manage data in the server 630.

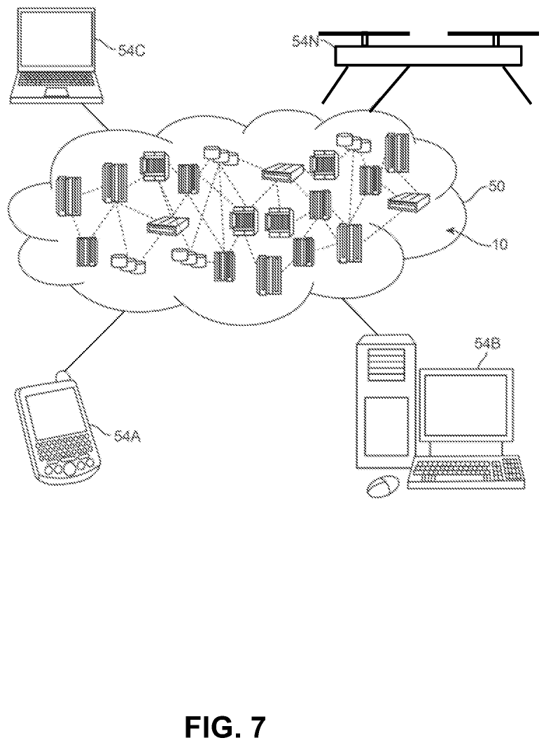

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or UAV 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

1. A method comprising:
receiving, by a processor having addressable memory, a spatial location of one or more known assets;
determining, by the processor, one or more clusters based on the received spatial location of the one or more known assets;
determining, by the processor, a bound for each asset of the one or more known assets in each cluster; and
determining, by the processor, a flight plan for an aerial vehicle for each cluster, wherein the flight plan surveys each asset in each cluster.

2. The method of claim 1, wherein the one or more known assets comprise at least one of: spaced out infrastructure, oil and gas infrastructure, a pipeline, and high voltage power lines.

3. The method of claim 1, wherein the one or more known assets comprise at least one of: assets needing a visual inspection, assets needing an electro-optical inspection, and assets needing an infrared inspection.

4. The method of claim 1, wherein the one or more known assets comprise at least one of: infrastructure and equipment that can potentially emit trace gasses.

5. The method of claim 4, wherein each cluster comprises a closed-shape polygon, wherein each cluster is created so as to have a minimal overlap with adjacent clusters, and wherein each cluster has a substantially similar area of coverage as each adjacent cluster.

6. The method of claim 1 further comprising:
receiving, by the processor, a spatial location having one or more known assets.

7. The method of claim 1 further comprising:
adjusting, by the processor, a cluster of the one or more clusters based on one or more known assets within a proximity to the cluster of the one or more clusters.

8. The method of claim 1 further comprising:
determining, by the processor, a location of a launch platform for an aerial vehicle having one or more sensors.

9. The method of claim 1, wherein the determined bound is based on at least one of: a wind data, an asset type, and a user preference.

10. The method of claim 1, wherein the determined bound comprises a minimum distance from a known asset of the one or more known assets.

11. The method of claim 10, wherein the determined bound further comprises a maximum distance from the known asset of the one or more known assets.

12. The method of claim 1, wherein the flight plan may be based on at least one of: a timeframe, a topology of the cluster, the determined bound for each asset, a wind data, an asset type for each asset, a user preference, a location of a launch platform for the aerial vehicle, a power level of the aerial vehicle, one or more constraints, and one or more cost functions.

13. The method of claim 1, further comprising:
determining, by the processor, a sub-cluster of one or more known assets, wherein the determined sub-cluster is based on a location of one or more known assets grouped within a set proximity, wherein the flight plan surveys each sub-cluster as a single asset.

14. A system comprising:
an aerial vehicle;
a global positioning system disposed on the aerial vehicle to determine a location of the aerial vehicle;
at least one sensor disposed on the aerial vehicle, the at least one sensor configured to generate sensor data; and
a processor having addressable memory, the processor configured to:
receive a spatial location of one or more known assets;
determine one or more clusters based on the received spatial location of the one or more known assets;
determine a bound for each asset of the one or more known assets in each cluster; and
determine a flight plan for the aerial vehicle for each cluster, wherein the flight plan surveys each asset in each cluster.

15. The system of claim 14, wherein the one or more known assets comprise at least one of: spaced out infrastructure, oil and gas infrastructure, a pipeline, and high voltage power lines.

16. The system of claim 14, wherein the one or more known assets comprise at least one of: assets needing a visual inspection, assets needing an electro-optical inspection, and assets needing an infrared inspection.

17. The system of claim 14, wherein the one or more known assets comprise at least one of: infrastructure and equipment that can potentially emit trace gasses.

18. The system of claim 17, wherein each cluster comprises a closed-shape polygon, wherein each cluster is created so as to have a minimal overlap with adjacent clusters, and wherein each cluster has a substantially similar area of coverage as each adjacent cluster.

19-26. (canceled)

27. A system comprising:
a portable device;
a global positioning system disposed on the portable device to determine a location of the portable device;
at least one sensor disposed on the portable device, the at least one sensor configured to generate sensor data; and
a processor having addressable memory the processor configured to:
receive a spatial location of one or more known assets, wherein the one or more known assets comprise at least one of: infrastructure and equipment that can potentially emit trace gasses;
determine one or more clusters based on the received spatial location of the one or more known assets, wherein each cluster comprises a closed-shape polygon, wherein each cluster is created so as to have a minimal overlap with adjacent clusters, and wherein each cluster has a substantially similar area of coverage as each adjacent cluster;
determine a bound for each asset of the one or more known assets in each cluster; and
determine a plan for the portable device for each cluster, wherein the plan surveys each asset in each cluster.

28. The system of claim 27, wherein the portable device is a mobile platform.
